(19) United States
(12) Patent Application Publication
(10) Pub. No.: US 2023/0033671 A1
(43) Pub. Date: Feb. 2, 2023

(54) APPARATUS AND METHOD FOR SEARCHING FOR ROUTE OF NAVIGATION

(71) Applicants: HYUNDAI MOTOR COMPANY, Seoul (KR); Kia Corporation, Seoul (KR)

(72) Inventors: Jin Woo KIM, Seoul (KR); Kyowoong CHOO, Seoul (KR)

(73) Assignees: HYUNDAI MOTOR COMPANY, Seoul (KR); Kia Corporation, Seoul (KR)

(21) Appl. No.: 17/674,288

(22) Filed: Feb. 17, 2022

(30) Foreign Application Priority Data
Jul. 26, 2021 (KR) 10-2021-0098051

(51) Int. Cl. G01C 21/34

(52) U.S. Cl. CPC G01C 21/3492; G01C 21/343

(57) ABSTRACT

An apparatus and a method for searching for a route to a navigation are provided. The apparatus includes a communication device to receive probe data from a plurality of probe vehicles, and a controller to generate traffic information for each link based on the probe data, to calculate the reliability of the traffic information for the link, calculate a cost for the link based on the reliability, and search for a route to a destination, which has the minimum cost, based on the cost for the link.

### CROSS-REFERENCE TO RELATED APPLICATION

This application is based on and claims the benefit of priority to Korean Patent Application No. 10-2021-0098051, filed on Jul. 26, 2021, in the Korean Intellectual Property Office, the disclosure of which is incorporated herein in its entirety by reference.

### TECHNICAL FIELD

The present disclosure relates to an apparatus and method for searching for route of navigation including a technology of increasing the accuracy of an estimated time of arrival (ETA).

### BACKGROUND

In general, a navigation system provides, to a user, real-time traffic information for a specific area and the optimal route to a destination, which is generated based on the real-time traffic information, in response to a user request. In this case, the real-time traffic information refers to traffic information generated at a time point at which the user request for the traffic information is made.

Such traffic information is changed every moment. Accordingly, when a vehicle travels on the optimal route and arrives at a specific point, real-time traffic information at the specific point may differ from traffic information generated at the time point at which the user request for the traffic information is made.

Accordingly, the real-time traffic information (for example, a traveling speed) is detected based on probe data (for example, GPS data) received from a probe vehicle traveling on the route to the destination. In this case, to accurately detect the traffic information, the number of probe vehicles traveling on the route (links constituting the route to the destination) to the destination has to exceed a reference value (for example, 30).

According to a conventional technology of searching for the route of the navigation, since the route to the destination is searched based on traffic information on each link without considering the number of probe vehicles, a big difference is made between the ETA and a time actually taken to the destination, thereby degrading the level of the satisfaction of the user for a service.

The matter described in “Background” is made for the convenience of explanation, and may include matters other than a related art well known to those skilled in the art.

### SUMMARY

The present disclosure addresses the above-mentioned problems occurring in the prior art while maintaining advantages achieved by the prior art.

An aspect of the present disclosure provides an apparatus and a method for searching for a route of a navigation. The apparatus and method are capable of calculating the reliability of traffic information of links constituting the route of the navigation, calculating a cost for each link based on the reliability, and searching for a route, which has the minimum cost (e.g., a route having the lower or lowest cost in the possible routes), to a destination, based on the cost for each link. Therefore, the difference between an ETA and a time actually taken to the destination may be minimized, such that the level of the satisfaction of the user is improved.

The technical problems to be solved by the present disclosure are not limited to the aforementioned problems, and any other technical problems not mentioned herein will be clearly understood from the following description by those skilled in the art to which the present disclosure pertains. In addition, it can be easily understood that the objects and the features of the present disclosure are realized by means and the combination of the means claimed in appended claims.

According to an aspect of the present disclosure, an apparatus for searching for a route to a navigation may include a communication device to receive probe data from a plurality of probe vehicles, and a controller to generate traffic information for each link based on the probe data, to calculate the reliability of the traffic information for the link, calculate a cost for the link based on the reliability, and search for a route, which has a minimum cost, to a destination, based on the cost for the link.

According to an embodiment of the present disclosure, the controller may calculate the reliability, based on a number of the probe vehicles traveling on the link.

According to an embodiment of the present disclosure, the controller may calculate the reliability through following Equation 1,

$${T}_{link} = 1 - \frac{\vert {V}_{a v e} - {V}_{ref} \vert}{{V}_{ref}} \qquad Equation 1$$

in which Tₗᵢₙₖ denotes the reliability of the traffic information for the link, Vₐᵥₑ denotes an average of speeds of the probe vehicles traveling on the link, and V_{ref} denotes a reference speed on the link.

According to an embodiment of the present disclosure, the V_{ref} may be an average of speeds of a reference number of probe vehicles traveling on the link.

According to an embodiment of the present disclosure, the controller may calculate the cost for the link through following Equation 2,

$${C}_{link} = \frac{{L}_{link}}{{V}_{a v e} ⨯ {T}_{link}} + W \qquad Equation 2$$

in which Cₗᵢₙₖ denotes the cost for the link, Lₗᵢₙₖ denotes a length of the link, Vₐᵥₑ denotes an average of speeds of the probe vehicles traveling on the link, and Tₗᵢₙₖ denotes the reliability of the traffic information for the link, and W denotes a weight.

According to an embodiment of the present disclosure, the traffic information may be an average of speeds of probe vehicles traveling on each link.

According to an embodiment of the present disclosure, the probe data may include an identification and global positioning system data of the probe vehicle.

According to an embodiment of the present disclosure, the apparatus may further include an output device to display the route, which has the minimum cost, to the destination.

According to another aspect of the present disclosure, a method for searching for a route to a navigation may include receiving, by a communication device, probe data from a plurality of probe vehicles, generating, by a controller, traffic information for each link based on the probe data, calculating, by the controller, reliability of the traffic information for the link, calculating, by the controller, a cost for each link based on the reliability, and searching, by the controller, for a route, which has a minimum cost, to a destination, based on the cost for each link.

According to an embodiment of the present disclosure, the calculating of the reliability may include calculating the reliability, based on a number of probes traveling on the link.

According to an embodiment of the present disclosure, the calculating of the reliability may include calculating the reliability through following Equation 1,

$${T}_{link} = 1 - \frac{\vert {V}_{a v e} - {V}_{ref} \vert}{{V}_{ref}} \qquad Equation 1$$

in which Tₗᵢₙₖ denotes the reliability of the traffic information for the link, Vₐᵥₑ denotes an average of speeds of the probe vehicles traveling on the link, and V_{ref} denotes a reference speed on the link.

According to an embodiment of the present disclosure, the V_{ref} is an average of speeds of a reference number of probe vehicles traveling on the link.

According to an embodiment of the present disclosure, the calculating of the cost may include calculating the cost for the link through following Equation 2,

$${C}_{link} = \frac{{L}_{link}}{{V}_{a v e} ⨯ {T}_{link}} + W \qquad Equation 2$$

in which Cₗᵢₙₖ denotes the cost for the link, Lₗᵢₙₖ denotes a length of the link, Vₐᵥₑ denotes an average of speeds of the probe vehicles traveling on the link, and Tₗᵢₙₖ denotes the reliability of the traffic information for the link, and W denotes a weight.

According to an embodiment of the present disclosure, the traffic information may be an average of speeds of the probe vehicles traveling on the link.

According to an embodiment of the present disclosure, the probe data may include an identification and global positioning system data of each probe vehicle.

According to an embodiment of the present disclosure, the method may further include displaying, by an output device, the route, which has the minimum cost, to the destination.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating the configuration of an apparatus for searching for a route of a navigation, according to an embodiment of the present disclosure;

FIG. 2A is an image illustrating a first route 210 according to a conventional manner;

FIG. 2B is an image illustrating a second route 220 according to an embodiment of the present disclosure;

FIG. 2C is an image illustrating A area 211 in FIG. 2A;

FIG. 2D is an image illustrating B area 221 in FIG. 2B;

FIG. 3A is an image illustrating a first route 310 according to the conventional manner;

FIG. 3B is an image illustrating a second route 320 according to another embodiment of the present disclosure;

FIG. 3C is an image illustrating A area 311 in FIG. 3A;

FIG. 3D is an image illustrating B area 321 in FIG. 3B;

FIG. 4 is a flowchart illustrating a method for searching for a route of a navigation, according to an embodiment of the present disclosure; and

FIG. 5 is a block diagram illustrating a computing system to execute a method searching for a route of a navigation, according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions may not be provided in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order between the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

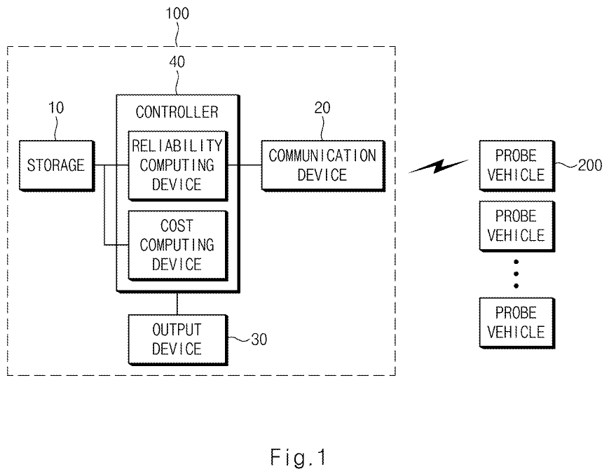

FIG. 1 is a view illustrating the configuration of an apparatus for searching for a route of a navigation, according to an embodiment of the present disclosure.

As illustrated in FIG. 1, according to an embodiment of the present disclosure, an apparatus 100 for searching for a route of a navigation may include a storage 10, a communication device 20, an output device 30, and a controller 40. In this case, according to an embodiment of the present disclosure, the components may be combined into each other to be implemented in one form, or some components may be omitted, depending on manners of reproducing the apparatus 100 for searching for the route of the navigation.

Regarding the components, the storage 10 may store various logics, various algorithms, and various programs required in the process of calculating the reliability of traffic information for each of links constituting a navigation route, calculating a cost for the link based on the reliability, and searching for a route, which has the minimum cost, to a destination, based on the cost for the link.

The storage 10 may store a reference speed used in the process of calculating the reliability of the traffic information for the links constituting the navigation route. In this case, reference speeds may have mutually different values depending on types (for example, a highway, a general road, or a city road) of a road, and the number of lanes.

The storage 10 may store a detailed map of the navigation, and the detailed map of the navigation may include a plurality of links used to constitute the route.

The storage 10 may include at least one storage medium including at least one of a memory in a flash memory type, a hard disk type, a micro type, or the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The communication device 20 is a module that provides a communication interface with the probe vehicle 200, and may periodically receive probe data from a plurality of probe vehicles 200. In this case, the probe data may include identification data (ID), global positioning system (GPS) data, or a traveling speed.

The communication device 20 may include at least one of a mobile communication module, a wireless Internet module, or a short-range wireless communication module.

The mobile communication module may make communication with the probe vehicle 200 over a mobile communication network constructed depending on technology standards or communication schemes for mobile communication. For example, the technology standards or communication schemes for mobile communication may include Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), or Long Term Evolution-Advanced (LTEA).

The wireless Internet module, which is a module for wireless Internet access, may make communication with the probe vehicle 200 through Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), or Long Term Evolution-Advanced (LTE-A).

The short-range communication module may support short-range communication with the probe vehicle 200 through at least one of Bluetooth™, Radio Frequency Identification (RFID), Infrared Data Association (IrDA), Ultra Wideband (UWB), ZigBee, Near Field Communication (NFC), or Wireless Universal Serial Bus (USB).

The output device 30 may display a route to a destination, which is found by the controller 40 and has the minimum cost. The output device may include a display and/or a voice output device, such as a speaker.

The controller 40 may perform the overall control such that the components normally perform the respective functions. In addition, the controller 40 may be implemented in the form of hardware or software, and may be implemented in the form of the combination of the hardware and the software. Preferably, the controller 40 may be implemented with a micro-processor, but the present disclosure is not limited thereto.

In particular, the controller 40 may store various logics, various algorithms, and various programs required in the process of calculating the reliability of traffic information on each of the links constituting the navigation route, calculating a cost for the link based on the reliability, and searching for the route, which has the minimum cost, to the destination, based on the cost for the link.

The controller 40 may generate the traffic information for each link, based on the probe data which is acquired through the communication device 20. In this case, the traffic information may include an average (average speed) of speeds of probe vehicles 200 traveling on the link.

Hereinafter, the operation of the controller 40 will be described.

The controller 40 may use Equation 1 in the procedure of calculating the reliability (Tₗᵢₙₖ) for traffic information for each of links constituting the navigation route. For reference, according to Central Limit Theorem of probability statistics, when k samples having a proper size are sampled, the mean of the samples follows a normal distribution, regardless of the distribution of a population. Accordingly, V_{ref} follows the normal distribution in following Equation 1.

$${T}_{link} = 1 - \frac{\vert {V}_{a v e} - {V}_{ref} \vert}{{V}_{ref}} \qquad Equation 1$$

In this case, Vₐᵥₑ denotes the average of speeds of the probe vehicles 200 travelling on the link and V_{ref} denotes the reference speed on the link. In this case, V_{ref}, which is the average of speeds of the reference number of probe vehicles 200 measured when the reference number of probe vehicles 200 (e.g., 30 probe vehicles) travel on the link, may be varied depending on the types of roads and the number of lanes of the road.

For example, when the traveling speed of a probe vehicle “A” traveling on the link is 80 kph, the traveling speed of a probe vehicle “B” is 90 kph, and the reference speed on the link is 90 kph, the reliability (Tₗᵢₙₖ) of the link is 0.95.

For another example, when the traveling speed of the probe vehicle “A” traveling on the link is 80 kph, the traveling speed of the probe vehicle “B” is 90 kph, the traveling speed of a probe vehicle “C” is 88 kph, the traveling speed of a probe vehicle “D” is 90 kph, the traveling speed of a probe vehicle “E” is 86 kph, and the reference speed on the link is 90 kph, the reliability (Tₗᵢₙₖ) of the link is 0.965.

The controller 40 may use, for example, following Equation 2 in the procedure of calculating a cost (Cₗᵢₙₖ) for each link based on the reliability (Tₗᵢₙₖ).

$${C}_{link} = \frac{{L}_{link}}{{V}_{a v e} ⨯ {T}_{link}} + W \qquad Equation 2$$

In this case, Lₗᵢₙₖ denotes the length of the link, Vₐᵥₑ means the average speed of the probe vehicles 200 traveling on the link, and W, which is a weight, may be varied depending on the link condition.

The controller 40 may search for the route, which has the minimum cost, to the destination, based on the cost for each link.

For an example, when links constituting a first route from a departure to a destination are “A” (cost=300), “B” (cost=200), and “C” (cost=100), and links constituting a second route are “A” (cost=300), “D” (cost=150), and “C” (cost=100), the cost for the first route is 600 and the cost for the second route is 550. Accordingly, the controller 40 may select the second route that has a lower cost than the first route.

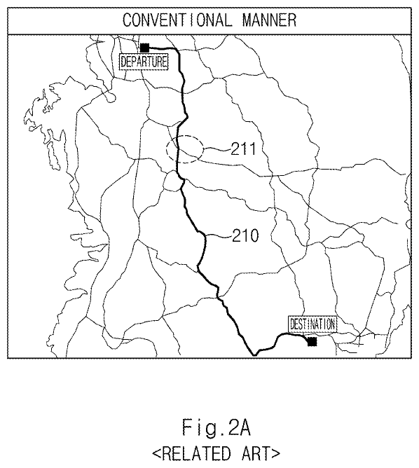

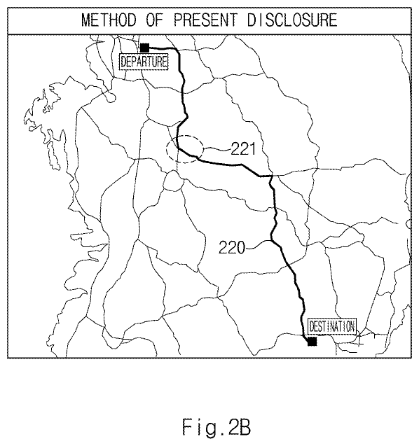

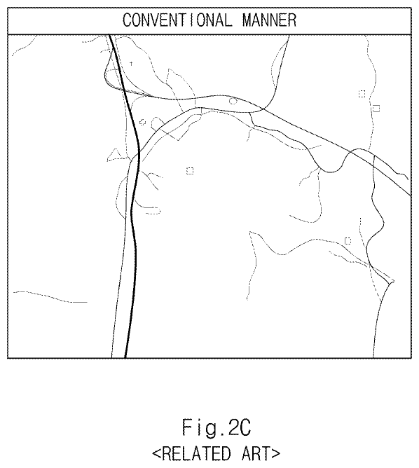

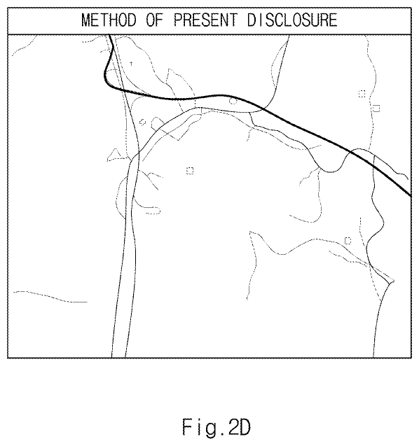

FIG. 2A is an image illustrating a first route 210 according to a conventional manner. FIG. 2B is an image illustrating a second route 220 according to an embodiment of the present disclosure.

As illustrated in FIGS. 2A and 2B, it may be recognized that a first route 210 from the departure to the destination, which is found according to the conventional manner, is different from a second route 220 from the departure to the destination, which is found according to a method of the present disclosure. In this case, the departure and the destination of the first route 210 are the same as the departure and the destination of the second route 220.

According to the conventional manner, regarding the first route 210, a total distance is 364,044 m, the total cost is 17,400, and the ETA is 3 hours 43 minutes 20 seconds, but the actually taken time is 3 hours 58 minutes 43 seconds. Accordingly, an error of 15 minutes and 23 seconds occurs with respect to the first route 210. In this case, the total cost is the sum of costs of the links constituting the first route 210.

Meanwhile, according to the method of the present disclosure, regarding the second route 220, a total distance is 339,084 m, the total cost is 14,900, and the ETA is 3 hours 34 minutes 46 seconds, but the actually taken time is 3 hours 39 minutes 10 seconds. Accordingly, an error of 4 minutes and 24 seconds occurs with respect to the second route 220.

Accordingly, it may be recognized that the method of the present disclosure more minimizes the difference between the ETA and the actually taken time, as compared to the conventional manner. This is because the method of the present disclosure is to form a route using a link having higher reliability.

In addition, according to the conventional manner, the first route 210 includes an A area 211, because the first route 210 is not based on the reliability of traffic information for a link constituting the route to the destination. According to the method of the present disclosure, the second route 220 includes a B area 221, because the second route 220 is based on the reliability of traffic information for a link constituting the route to the destination.

FIG. 2C is an image illustrating A area 211 in FIG. 2A. FIG. 2D is an image illustrating B area 221 in FIG. 2B.

In this case, regarding the A area 211 and the B area 221, as illustrated in FIGS. 2C and 2D, respectively, the number of probe vehicles 200 contributing to the traffic information for each of links included in the A area 211 and the number of probe vehicles 200 contributing to the traffic information for each of links included in the B area 221 are as shown in Table 1.

TABLE 1

| Conventional | | Method of the present | |
|---|---|---|---|
| Manner | | disclosure | |
| | The number | | The number |
| Link | of probe | Link | of probe |
| ID | vehicles | ID | vehicles. |
| 1779297 | 55 | 1779312 | 151 |
| 1753212 | 20 | 3975290 | 381 |
| 2690576 | 9 | 4962630 | 365 |

It may be recognized through Table 1 that the number of probe vehicles 200, which contribute to the traffic information for links selected according to the method of the present disclosure, is larger than the number of probe vehicles which contribute to the traffic information for links selected according to the conventional manner. This refers to that the traffic information for the links selected according to the method of the present disclosure has reliability higher than the traffic information for the links selected according to the conventional manner.

As illustrated in FIGS. 2C and 2D, the A area 211 includes the total of three links as in table 1, and the B area 221 includes the total of three links as in table 1. In this case, the links included in the A area 221 are different from the links included in the B area 221.

Accordingly, the number of probe vehicles 200, which contribute to the traffic information for links selected according to the method of the present disclosure, is larger than the number of probe vehicles contributing to the traffic information for links selected according to the conventional manner. Therefore, the traffic information for the links selected according to the method of the present disclosure has reliability higher than the traffic information for the links selected according to the conventional manner. This results in that the difference between the ETA and the actually taken time on the second route 220 according to the method of the present disclosure is significantly less than the difference between the ETA and the actually taken time, on the first route 210 according to the conventional method.

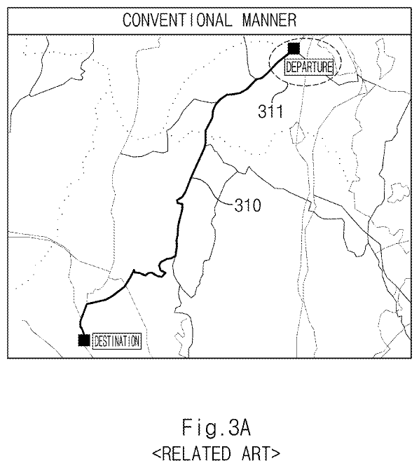

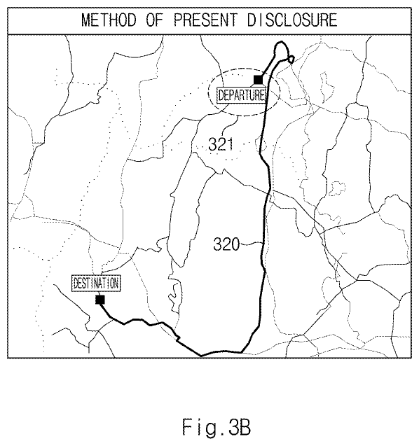

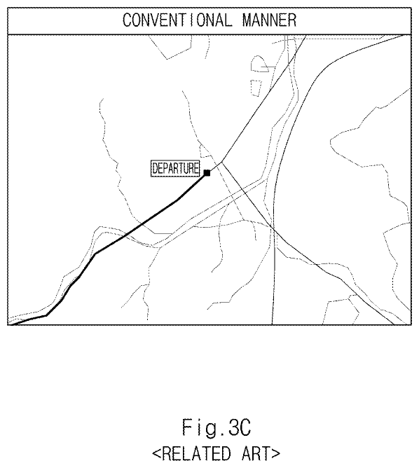

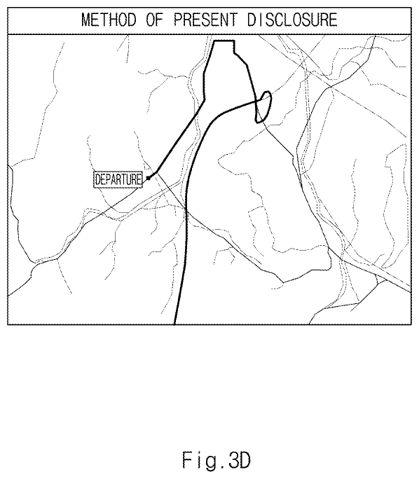

FIG. 3A is an image illustrating a first route 310 according to the conventional manner. FIG. 3B is an image illustrating a second route 320 according to another embodiment of the present disclosure.

As illustrated in FIGS. 3A and 3B, it may be recognized that a first route 310 from the departure to the destination, which is found according to the conventional manner is different from a second route 320 from the departure to the destination, which is found according to the method of the present disclosure. In this case, the departure and the destination of the first route 310 are the same as the departure and the destination of the second route 320.

According to the conventional manner, regarding the first route 310, a total distance is 31,647 m, the total cost is 3600, and the ETA is 45 minutes 23 seconds, but the actually taken time is 49 minutes 48 seconds. Accordingly, an error of 4 minutes and 25 seconds occurs with respect to the first route 310.

Meanwhile, according to the method of the present disclosure, regarding the second route 320, a total distance is 51,351 m, the total cost is 3500, and the ETA is 40 minutes 57 seconds, but the actually taken time is 43 minutes 17 seconds. Accordingly, an error of 2 minutes and 20 seconds occurs with respect to the second route 320.

Accordingly, it may be recognized that the method of the present disclosure more minimizes the difference between the ETA and the actually taken time, as compared to the conventional manner. This is because the method of the present disclosure is to form a route using a link having higher reliability.

In addition, according to the conventional manner, the first route 310 includes an A area 311, because the first route 310 is not based on the reliability of the traffic information for the link constituting the route to the destination. According to the method of the present disclosure, the second route 320 includes a B area 321, because the second route 320 is based on the reliability of the traffic information for the link constituting the route to the destination.

FIG. 3C is an image illustrating A area 311 in FIG. 3A. FIG. 3D is an image illustrating B area 321 in FIG. 3B.

In this case, regarding the A area 311 and the B area 321, as illustrated in FIGS. 3C and 3D, respectively, the number of probe vehicles 200 contributing to the traffic information for each link included in the A area 311 and the number of probe vehicles 200 contributing to the traffic information for each link included in the B area 321 are as shown in Table 2.

TABLE 2

| Conventional | | Method of the | |
|---|---|---|---|
| manner | | present disclosure | |
| | The number | | The number |
| Link | of probe | Link | of probe |
| ID | vehicles | ID | vehicles |
| 1622421 | 828 | 1621974 | 4,379 |
| 1621527 | 937 | 1620666 | 3,666 |

It may be recognized through Table 2 that the number of probe vehicles 200 contributing to the traffic information for links selected according to the method of the present disclosure is larger than the number of probe vehicles contributing to the traffic information for links selected according to the conventional manner. This refers to that the traffic information for the selected links according to the method of the present disclosure has reliability higher than the traffic information for the selected links according to the conventional manner.

As illustrated in FIGS. 3C and 3D, the A area 311 includes the total of two links as in table 2, and the B area 321 includes the total of two links as in table 2. In this case, the links included in the A area 321 are different from the links included in the B area 321.

Accordingly, the number of probe vehicles 200 contributing to the traffic information for the links selected according to the method of the present disclosure, is larger than the number of probe vehicles contributing to the traffic information for the links selected according to the conventional manner. Therefore, the traffic information for the links selected according to the method of the present disclosure has reliability higher than the traffic information for the links selected according to the conventional manner. This results in that the difference between the ETA and the actually taken time on the second route 320 according to the method of the present disclosure is significantly less than the difference between the ETA and the actually taken time on the first route 310 according to the conventional method.

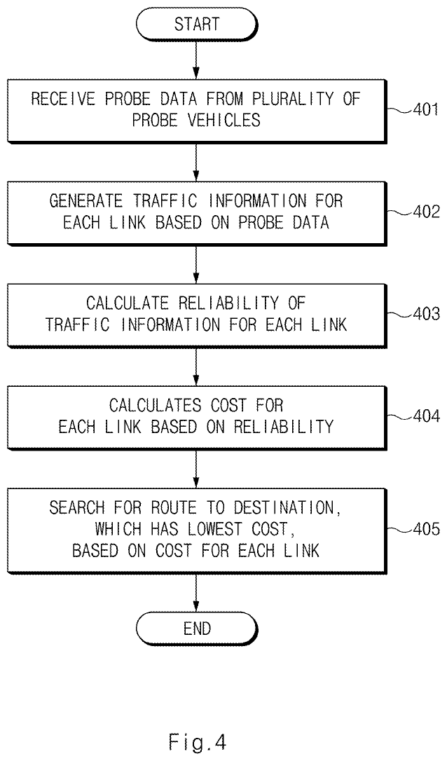

FIG. 4 is a flowchart illustrating a method for searching for a route of a navigation, according to an embodiment of the present disclosure.

First, the communication device 20 receives probe data from a plurality of probe vehicles (401).

Thereafter, the controller 40 generates traffic information for each link based on the probe data (402).

Thereafter, the controller 40 calculates the reliability of the traffic information for each link (403).

Subsequently, the controller 40 calculates a cost for each link based on the reliability (404).

Then, the controller 40 may search for a route, which has the minimum cost, to the destination, based on the cost for each link (405).

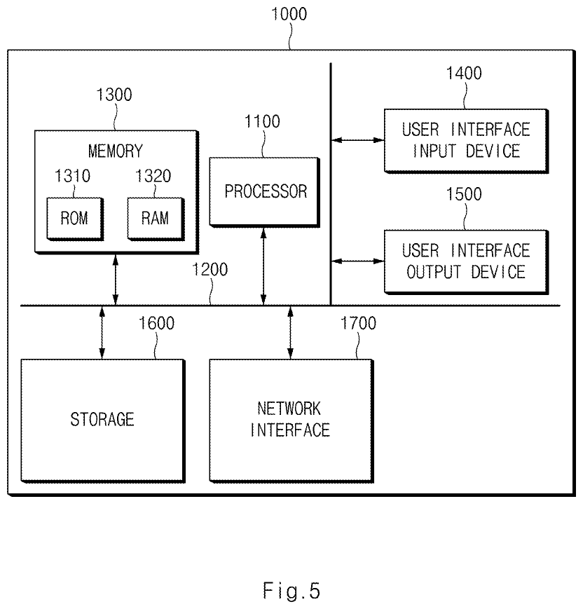

FIG. 5 is a block diagram illustrating a computing system to execute a method for searching for a route of a navigation, according to an embodiment of the present disclosure.

Referring to FIG. 5, according to an embodiment of the present disclosure, the method for searching for the route of the navigation may be implemented through a computing system. A computing system 1000 may include at least one processor 1100, a memory 1300, a user interface input device 1400, a user interface output device 1500, a storage 1600, and a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only ROM 1310 and a RAM 1320.

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the storage 1600), such as a RAM memory, a flash memory, a ROM, memory an erasable and programmable ROM (EPROM), an electrically EPROM (EEPROM), a register, a hard disc, a solid state drive (SSD), a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, according to an embodiment of the present disclosure, in the apparatus and the method for searching for the route of the navigation, the reliability of traffic information for links constituting the route of the navigation may be calculated, the cost for each link may be calculated based on the reliability, and the route, which has the minimum cost, to the destination, may be searched based on the cost for each link, thereby minimizing the difference between an ETA and a time actually taken to the destination, such that the level of the satisfaction of the user is improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be construed by the attached claims, and all equivalents thereof should be construed as being included within the scope of the present disclosure.

What is claimed is:

1. An apparatus for searching for a route of a navigation, the apparatus comprising:
a communication device to receive probe data from a plurality of probe vehicles; and
a controller to:
generate traffic information for each link, based on the probe data;
calculate reliability of the traffic information for the link;
calculate a cost for the link based on the reliability; and
search for a route, which has a minimum cost, to a destination, based on the cost for the link.

2. The apparatus of claim 1, wherein the controller is to:
calculate the reliability, based on a number of the probe vehicles traveling on the link.

3. The apparatus of claim 1, wherein the controller is to:
calculate the reliability through following Equation 1,
$${T}_{link} = 1 - \frac{\vert {V}_{a v e} - {V}_{ref} \vert}{{V}_{ref}} \qquad Equation 1$$
in which Tₗᵢₙₖ denotes the reliability of the traffic information for the link, Vₐᵥₑ denotes an average of speeds of the probe vehicles traveling on the link, and V_{ref} denotes a reference speed on the link.

4. The apparatus of claim 3, wherein the V_{ref} is an average of speeds of a reference number of probe vehicles traveling on the link.

5. The apparatus of claim 1, wherein the controller is to:
calculate the cost for the link through following Equation 2,
$${C}_{link} = \frac{{L}_{link}}{{V}_{a v e} ⨯ {T}_{link}} + W \qquad Equation 2$$
in which Cₗᵢₙₖ denotes the cost for the link, Lₗᵢₙₖ denotes a length of the link, Vₐᵥₑ denotes an average of speeds of the probe vehicles traveling on the link, and Tₗᵢₙₖ denotes the reliability of the traffic information for the link, and W denotes a weight.

6. The apparatus of claim 1, wherein the traffic information is an average of speeds of the probe vehicles traveling on the link.

7. The apparatus of claim 1, wherein the probe data includes:
an identification and global positioning system data of each probe vehicle.

8. The apparatus of claim 1, further comprising:
an output device to display the route, which has the minimum cost, to the destination.

9. A method for searching for a route to a navigation, the method comprising:
receiving, by a communication device, probe data from a plurality of probe vehicles;
generating, by a controller, traffic information for each link based on the probe data;
calculating, by the controller, reliability of the traffic information for the link;
calculating, by the controller, a cost for the link based on the reliability; and
searching, by the controller, for a route, which has a minimum cost, to a destination, based on the cost for the link.

10. The method of claim 9, wherein the calculating of the reliability includes:
calculating the reliability, based on a number of probes traveling on the link.

11. The method of claim 9, wherein the calculating of the reliability includes:
calculating the reliability through following Equation 1,
$${T}_{link} = 1 - \frac{\vert {V}_{a v e} - {V}_{ref} \vert}{{V}_{ref}} \qquad Equation 1$$
in which Tₗᵢₙₖ denotes the reliability of the traffic information for the link, Vₐᵥₑ denotes an average of speeds of the probe vehicles traveling on the link, and V_{ref} denotes a reference speed on the link.

12. The method of claim 11, wherein the V_{ref} is an average of speeds of a reference number of probe vehicles traveling on the link.

13. The method of claim 9, wherein the calculating of the cost includes:
calculating the cost for the link through following Equation 2,
$${C}_{link} = \frac{{L}_{link}}{{V}_{a v e} ⨯ {T}_{link}} + W \qquad Equation 2$$
in which Cₗᵢₙₖ denotes the cost for the link, Lₗᵢₙₖ denotes a length of the link, Vₐᵥₑ denotes an average of speeds of the probe vehicles traveling on the link, and Tₗᵢₙₖ denotes the reliability of the traffic information for the link, and W denotes a weight.

14. The method of claim 9, wherein the traffic information is an average of speeds of the probe vehicles traveling on the link.

15. The method of claim 9, wherein the probe data includes:
an identification and global positioning system data of each probe vehicle.

16. The method of claim 9, further comprising:
displaying, by an output device, the route, which has the minimum cost, to the destination.
